(19) United States
(12) Patent Application Publication
(10) Pub. No.: US 2009/0119784 A1
(43) Pub. Date: May 7, 2009

(54) OUT OF BAND LICENSE ACQUISITION INCLUDING CONTENT IDENTIFICATION

(75) Inventors: Albhy Galuten, Santa Monica, CA (US); Hisato Shima, Tokyo (JP)

Correspondence Address: Trellis Intellectual Property Law Group, PC, 1900 EMBARCADERO ROAD, SUITE 109, PALO ALTO, CA, 94303, US

(73) Assignees: Sony Corporation, Tokyo (JP); Sony Cprporation of America, New York, NY (US)

(21) Appl. No.: 12/245,674

(22) Filed: Oct. 3, 2008

Related U.S. Application Data
(63) Continuation-in-part of application No. 12/131,860, filed on Jun. 2, 2008.
(60) Provisional application No. 61/002,300, filed on Nov. 7, 2007.

(51) Int. Cl. G06F 21/24; H04L 9/32

(52) U.S. Cl. 726/33; 726/26

(57) ABSTRACT

Particular embodiments generally relate to transferring data with first usage rights to a device and presenting the data by a receiving device by using different usage rights. The receiving device contacts one or more services that can determine what rights are available and can issue those rights to the receiving device. The receiving device is challenged to identify the received content. The receiving device can update the state across devices and services that maintain compliance with the usage rights.

### CROSS REFERENCE TO RELATED APPLICATIONS

This application is a Continuation-In-Part application and claims priority from U.S. patent application Ser. No. 12/131,860 entitled METHOD FOR OUT OF BAND LICENSE ACQUISITION ASSOCIATED WITH CONTENT REDISTRIBUTED USING LINK PROTECTION, filed on Jun. 2, 2008, which is hereby incorporated by reference as if set forth in full in this application for all purposes.

This application claims priority from U.S. Provisional Patent Application Ser. No. 61/002,300, entitled METHOD FOR OUT OF BAND LICENSE ACQUISITION ASSOCIATED WITH CONTENT REDISTRIBUTED USING LINK PROTECTION, filed on Nov. 7, 2007, which is hereby incorporated by reference as if set forth in full in this application for all purposes.

### BACKGROUND

Particular embodiments generally relate to computing and more specifically to consumer electronic devices and network services.

Users may have protected content on one device and wish to have that content on another device. Those devices may use different content protection mechanisms. Both content devices may support a common link protection mechanism like Digital Transport Content Protection (DTCP). The user may not want to reacquire the content from the original service provider due to bandwidth or other considerations. The transmission protocol may not be able to precisely express the usage rules associated with the content.

For example, assume a user has purchased some content from an Internet service provider and downloads the content to one device. The user wishes to have that content on another device but, if those two devices use different content protection technology, also referred to as Digital Rights Management (DRM), then the content can not be directly copied from one device to another because the encrypted content file format may be different and the content license file format may also be different.

In this case, one prior-art approach is that the user acquires content again from the service site. The user downloads the same content to another device using the content protection technology for the second device. This may work but downloading a large content file again from an Internet service may be time-consuming and could incur additional fees for transmission or for reacquisition from the service. Therefore, the user may not want to reacquire the content from the original service provider.

Another prior art approach is to copy the content locally using a common link protection mechanism like DTCP. This approach also works but in this case, only the usage rules expressed in the link protection technology can be transferred. For example, DTCP uses simple usage rule expressions such as “copy-one-generation,” “copy-never,” etc. and may not be able to precisely express the usage rules associated with the content. For example, content may have been licensed to the user for limited time, but if the limitation is not expressed in the DTCP format, the content is transferred as “copy never,” thus preventing the user from making a copy of the content.

### SUMMARY

Particular embodiments generally relate to transferring content from one device to another using link protection (e.g. DTCP). The rights associated with the content are reacquired from an Online License Service that has knowledge of the sending device, the receiving device and the content. The receiving device is challenged to identify the received content. The Online License Service is able to send the receiving device a license for the transferred content and the receiving device is able to use those rights and its native DRM system to protect the received content and associate the appropriate rights with that content. The content, which can be a relatively large file, can be transferred locally and the license, which is typically a smaller file, is downloaded from the service. The license file has full expression capability of the native DRM system used in the destination device.

In a general case, content can be transferred from a first device to a second device under first licensing terms. As a result of the transfer (e.g., streaming), a second license with different license terms can be obtained from a License Coordination Service and be used to control the playback or other use of the content irrespective of the first license terms.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts a system for issuing licenses to devices using different DRMS from separate License Issuers.

FIG. 2 depicts a system for issuing licenses to devices using different DRMS where the different License Issuers are controlled by the same entity.

FIG. 3 depicts a simplified flowchart for gathering necessary information and using that information to issue the appropriate licenses.

FIG. 4 illustrates an example of a streaming protocol used in DTCP.

FIG. 5 depicts a flowchart for another method for gathering necessary information and using that information to issue the appropriate licenses.

FIG. 6 illustrates use of metadata to assist in content identification.

### DETAILED DESCRIPTION OF EMBODIMENTS

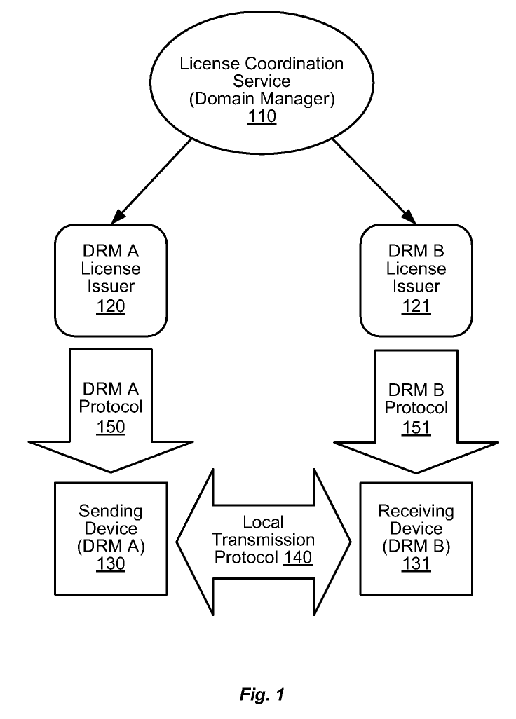

FIG. 1 depicts a system for issuing licenses to devices using different DRMS from separate License Issuers. In FIG. 1, devices 130 & 131 can have a copy of content. They could be Consumer Electronics devices such as cell phones, set-top boxes, audio players, personal computing systems (PCs), etc. In general, any device that can play back or present audio and/or visual content can be suitable for use. In this example, the source (or sending) Device 130 uses DRM A and sink (or receiving) Device 131 uses DRM B. For example, both devices can be owned by one user and reside in that user's home as illustrated by box 150. DRM A and DRM B are different rights management systems. Typically, different rights management systems will have interoperability issues. For example, the manner, type and format of a license, license grant, authentication or other characteristics of rights management are likely to be incompatible. Further, different rights management systems can be owned and operated by different entities (e.g., companies, standards bodies, administrative agencies, etc.) that are not in communication with each other or may have adverse interests such as where two different companies are in competition. Because of interoperability issues, content transferred to the receiving device may not be playable on the receiving device.

Communications Protocol 140 includes a protocol used for link protection of content when the content is transmitted between two devices that may not share the same DRM. Communications Protocol 140 is usually used on a home network.

Devices 130 and 131 use services 120 and 121 respectively. Protocol 150 is used for DRM A and Protocol 151 is used for DRM B. Services 120 & 121 are license issuers for their respective DRMs. Service 110 coordinates licenses between two or more license issuers. Services 110, 120 & 121 are usually provided to a user via the Internet by hardware and software located outside of the user's home.

Because devices 130 and 131 may be associated with different DRMs, they can not necessarily decrypt the same content or read the same licenses. However they can both send content using a common secure transmission protocol 140 (e.g., DTCP). This protocol does not however express the rich set of rights that are usually associated with content that is protected by a DRM. For example, DRM A may allow for playing content within a period of time (e.g., up to two weeks after purchase) but that same rights feature may not be conveyable by secure transmission protocol 140 and may not exist within the definition of DRM B.

Because DRM License Issuers 120 & 121 may only know about the devices that use their particular DRM, it is necessary to have a License Coordination Service or Domain Manager to keep track of the rights associated with the different devices. The License Coordination Service manages devices for the user (domain manager) and may also maintain the list of content and its usage rules licensed to the user (Rights Locker).

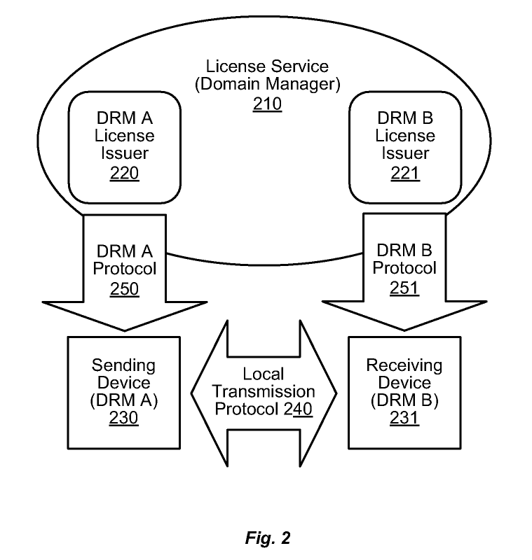

In one embodiment, as depicted in FIG. 2, the DRM license issuers are both controlled by the same entity and the data associated with the different devices and content elements (or the “state”) are stored in a common database. This should be viewed as a simplification of the architecture expressed in FIG. 1.

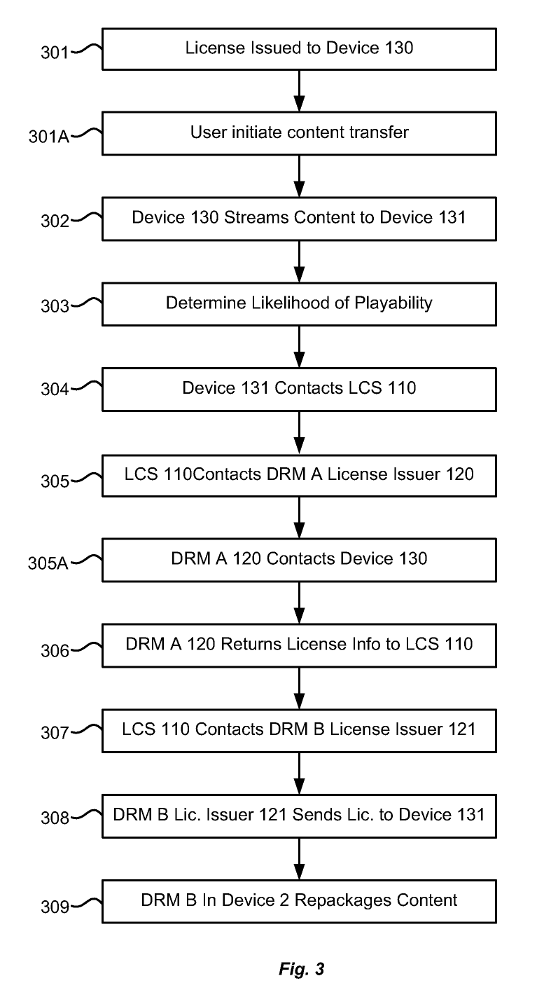

FIG. 3 describes the steps as outlined below. In this explanation, the entities in FIG. 1 are used.

In step 301, the content is acquired by Device 130 and a license is issued to Device 130. This device 130 may already be registered with the License Coordination Service 110 and might be considered as part of the User's Domain of Devices. This license is typically for a particular piece or set of content and is associated with a usage model (e.g. the user can play the content in perpetuity on any of their devices).

In step 301A, the sending device and receiving device are selected. Some content in the sending device is also selected for transfer. For example, Digital Living Network Alliance (DLNA) guidelines base on a Universal Plug and Play (UPnP) protocol may be used. In general, any suitable communication link, protocol and data format can be used to achieve data transfers.

In step 302, Device 130 sends the content to device 131 using a secure streaming protocol like DTCP. The secure streaming protocol typically authenticates the device and shares a common secret key to establish a Secure Authenticated Channel (SAC) between two participating devices. The content encrypted in DRM A format is decrypted and then encrypted during transmission using a common secret key in the format defined by the secure streaming protocol. The receiving device decrypts the content using the common key and encrypts it in the format for DRM B. The expression of rights may be very limited using this protocol. For example, the content may, as defined in the protocol, only be expected to be rendered and only ephemeral copies permitted for the purpose of rendering. This would not, by itself, permit the receiving device to persistently store the content. The stream may include information necessary for the later step of the sequence, such as Domain ID etc.

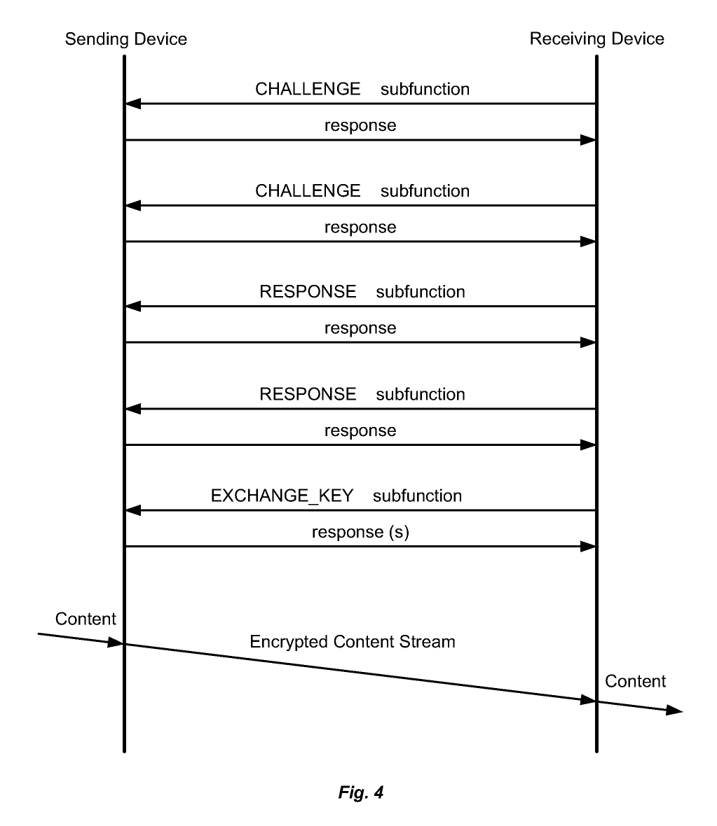

FIG. 4 illustrates an example of transactions in a streaming protocol used in DTCP. Details of these transactions can be found in, for example, Digital Transmission Content Protection Specification Revision 1.4 (Informational Version).

In step 303, the receiving device 131 determines that the content can probably be stored and played on the receiving device 131 if it can get a license. This step is optional but may be helpful to avoid the situation where the rest of the step is performed and finally it turns out the content is not stored and played. There are a number of possible ways that the receiving device can determine whether or not it might be able to have the right to play this content. This step may happen before step 302, in the middle of step 302, or after step 302 depending how the receiving device retrieves necessary information for this determination:

In step 304, Device 131 contacts the License Coordination Service 110 (LCS) transmitting the information about the license(s) associated with the content on Device 130. The information may contain what the content is and what domain it is part of or what the copy count is. The integrity of the information may be protected by a signature generated by LCS. In this step Device 131 may contact LCS directly or through DRM license issuer 121, or through other intermediary nodes, as desired.

In step 305, the LCS contacts the DRM A License Issuer to confirm the nature of the license issued to Device 130.

In 305A, if it is copy count based, DRM A contacts Device 130 and decrements the copy count. Alternatively, if the Copy Count is stored at the LCS, the Copy Count is decremented there.

In 306, DRM A returns license information to the LCS (if it is not already stored there).

In 307, the LCS gives the license information to the DRM B License Issuer and instructs it to issue a license to Device 131. Note that the LCS may perform license duplication, modification, translation or other processes in order to provide a desired license to DRM B. For example, if DRM A has a license structure that allows a time range for an active license, but DRM B does not directly support a time range, then the LCS can implement the time period of active license by sending a non-time restricted license to DRM B but later revoking or invalidating the license when a timer maintained or tracked by the LCS expires. Other modifications of license behavior in order to achieve an equivalent license between two DRMs with incompatible license rules are possible.

In 308, the DRM B License Issuer sends the license to Device 131.

In 309, DRM B repackages the content as defined in the new license and it is stored by Device 131.

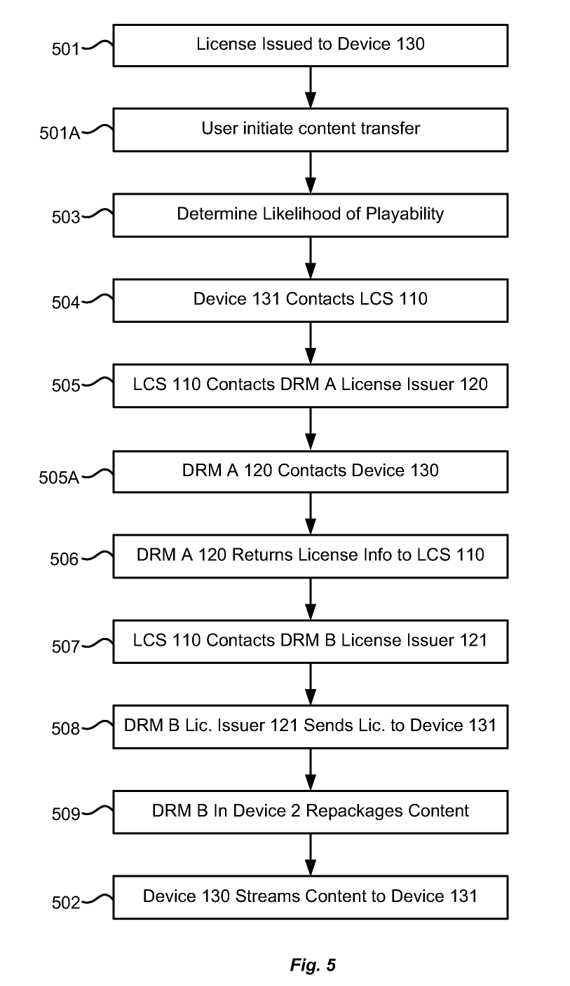

FIG. 5 illustrates alternate steps 503 through 509 that can occur before step 302 in a similar process to that described in FIG. 3. Steps 501 and 501A are the same as steps 301 and 301A of FIG. 3. In FIG. 5, the alternate steps are similar to steps 303 through 309, respectively, and can occur before step 502 (corresponding with step 302) in which content is streamed to the receiving device 131 as shown in FIG. 5. This sequence has benefits over the sequence shown in FIG. 3 as the receiving device 131 gets the new license before the content is streamed. By getting a license before the content is streamed, the receiving device can store the content using the content key for DRM B when content is streamed to device 131.

The distribution of the content between devices is controlled using several methods or combinations of them. One of the methods is a Domain membership. A Domain can be defined to include a group of several devices so that content can be copied or moved between devices in same domain and a same license can apply to each device's use of the content. Another method is Copy count where the number of copies of a specific content is limited to a value determined by the content provider. Domain and Copy count could be combined. For example, a limited number of copies can be permitted within a domain. The following paragraphs explain how these restrictions are implemented in a particular embodiment.

Assuming that the Receiving Device is in the same Domain as the sending device and the Receiving Device has the right to share domain content the Domain membership could be expressed in a number of different ways:
1. The Domain Membership can be described in the stream explicitly expressed using a domain ID. For example, a Domain ID can be embedded in the stream. The Domain ID in the stream is compared with the Domain ID of the receiving device so that the device's operations with the content can be treated as within the domain to which the content is associated.
2. The Domain Membership can be described in the stream indirectly by referencing an ID that can be resolved by the License Coordination Server. For example, an ID of the license can be used in a reference which identifies the license uniquely (including content, Domain etc.) which can be used by the LCS.
3. The Domain ID or some other indirect ID can be exposed through a home network protocol such as UPnP and passed to the receiving device in step 301A
4. Domain Memberships can be described by a license information file which can be found on the home network by the receiving device. The license information file can be encrypted for security. The license information file can be accessed by the receiving device prior to streaming as it might require interrogating the sending device for the stream in the first place either directly or through a proxy after having discovered the content—note this license information file could express the domain explicitly as above or indirectly by reference also as above. The license information file may include other information such as location of license coordination service.

Another type of license restriction/permission regulates the number of copies remaining to be made. Assuming that a certain number of copies were originally acquired by the sending device and copying is still allowed, then the copies remaining to be made could be expressed in the stream explicitly or in the stream indirectly by referencing the address where common state management is kept (e.g. at the common license manager).

Note that if the user has rights for a greater number of copies than originally acquired by the sending device, then an additional license can be acquired by the receiving device 131 without communicating with the sending device 130. Alternatively, the sending device 130 returns a license to the license issuer 120 before the receiving device request for the license. In the latter case, if the sending device loses the license for the content, it will delete its copy of the content once it completes the transfer (i.e., copying) of the content to the receiving device.

In step 301, a user can select device(s) and the content in several ways. Depending which device the user operates, there are three scenarios, called “Pull”, “Push” and “3 box”.

In the “Pull” scenario, the user operates the receiving device 131. Using protocols defined in DLNA and UPnP, the receiving device 131 looks for a sending device which has a media server function. Once the server device is found, the user browses the content directory of the server and finds content to copy using, for example, a content directory service defined by UPnP. The content directory service may deliver information for the user to identify the content. For example, the information can include the title of the content. In addition, a content directory service may be used to expose information for license acquisition such as a domain ID, Content ID and/or location of a License Coordination service. Alternatively, the content directory service may indicate the location of license information file which includes the information described above.

In the “Push” scenario, a user operates the sending device 130. Using a protocol defined in DLNA and UPnP, the sending device 131 looks for a receiving device which has a media server function with upload capability. Once the server function in the receiving device is found, the user browses content directories in the receiver to find the directory in which content can be transferred. Using the create object action of the content directory service, information for license acquisition such as domain ID, Content ID and/or location of License Coordination service could be delivered in association with the content being streamed or transferred to the receiving device.

In the three box scenario, the user operates the third device (a control device, not shown in FIG. 1). Using protocols defined in DLNA and UPnP, the control device looks for a sending device which has a media server function. The control device also looks for a receiving device which has a media server function with upload capability. After both devices are identified, the process is the same as described above.

As described above, various embodiments can allow a new license to be obtained that differs from an existing license associated with content transferred between two or more devices. A window for obtaining the new license can be based on the initiation of streaming. For example, a 90 minute window from the start of streaming can be permitted. In such a case the receiving device can store or cache the streamed content for the window period of time. Even if the DRM for the content instructs the receiving device to present the content immediately and then discard the content, such a requirement can be overridden by a first new license obtained from the LCS. The first new license can allow the receiver a window of time within which to obtain an additional desired license.

An alternative embodiment uses a content identification procedure as an additional security measure. Such content identification procedure can be used to prevent an attack whereby a license can be obtained for a first content and used to play back a second content. For example, sending device 130 of FIG. 1 may send Movie A to receiving device 131 with copy control information such as “copy never” which allows the receiving device to play the content once. The receiving device may obtain a license from license issuer 121 to retain (e.g. record for permanent usage) Movie B, which may already be authorized to play on the receiving device. While receiving Movie A from the sending device, the receiving device may claim that the movie being received is Movie B and may try to use the license for Movie B to play Movie A. In order to avoid this, the receiving device must be able to make a testable attestation that the content for which it is requesting the license is, in fact the content it has just received.

One mechanism to prevent the above outcome is for service 121 to challenge device 131 about the identity of the content being received. For example, service 121 may require device 131 to provide information specific to the content of the streamed file such as specific bytes, words or other portions of data from the file. If the specific information returned by device 131 matches identification data to prove the streamed file is really Movie A, then service 121 can send a license right and/or key to device 131 similar to the rights granting described, above. Alternatively, device 131 may be permitted to generate the license and/or key locally. This approach need not require participation or modification in the device or protocol behavior on the sending device side. The content-based identification can use any type and amount of the content. For example, a hash value of a block or section of the content data (in its unencrypted form) can be generated. Since the service that originally packaged the content has access to the original unencrypted data, it can generate a challenge that could only be responded to accurately by a device, in this case the receiving device, that also has access to the same unencrypted data. The challenge and/or attestation can occur at or before step 308 of FIG. 3. Other embodiments can perform the challenge and/or attestation actions at different points in the flowchart of FIG. 3.

Another embodiment can accomplish the content identification in other ways. For example, metadata or other additional data can be associated with the transferred file. The metadata can be hashed with all or a portion of the content. The hash can be signed and added to the file to be transferred. The hash and signature can be sent to the rights locker so that the signed hash is transmitted with the file when it is transferred to the receiving device. When the receiving device receives the file and hash and signature they are presented to the LCS. The LCS checks the hash and signature and, if ok, it sends the right to service 121 for transfer to the receiving device. The content can be encrypted either with (1) a new key generated locally or (2) a key sent to a local instance of the DRM by the service.

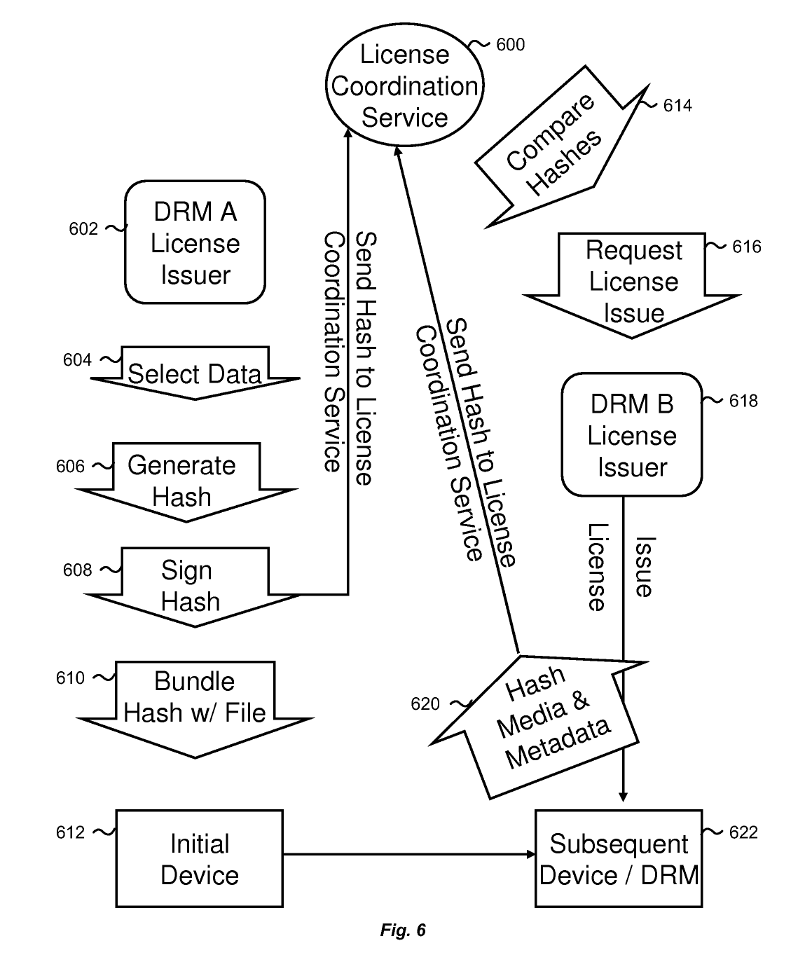

FIG. 6 illustrates using metadata to aid in content identification. In FIG. 6, the DRM A license issuer 602 performs steps to select data at 604, generate a hash of all or a portion of the data at 606, sign the hash at 608 and send the hash to LCS 600. The hash is bundled with the file at 610 and provided to initial (sending) device 612. When subsequent (receiving) device 622 obtains the transferred file, the hash and optional other information such as media content and/or additional metadata, are sent to the LCS at step 620.

The LCS then compares hashes at step 614, and requests DRM B License issuer 618 to issue a license at 616. DRM B license issuer 618 sends the license to the subsequent device 622 so that the received file may be played according to the granted rights.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A method for presenting content in a receiving device, the method comprising:
initiating transfer of the content from a sending device to the receiving device, wherein the content is associated with a first license, wherein the first license includes at least one digital rights management term;
in response to the initiating transfer, communicating with a license provider;
challenging the receiving device to identify at least a portion of the content;
receiving a second license in association with the content, wherein the second license includes at least one license right that differs from the at least one digital rights management terms; and
presenting the content in accordance with at least one term in the second license.

2. The method of claim 1, wherein the receiving device complies with a Digital Transport Content Protection standard.

3. The method of claim 1, wherein the receiving device implements at least a portion of a Digital Rights Management (DRM) approach.

4. The method of claim 1, wherein initiating a transfer is caused by a sending device, wherein the sending and receiving devices each include a DRM approach, wherein the DRM approaches have at least one rights term that causes an interoperability issue.

5. The method of claim 1, wherein a license provider includes a License Coordination Service.

6. The method of claim 1, further comprising:
establishing a time duration;
storing at least a portion of the content for the time duration; and
obtaining a license in association with the content within the time duration.

7. The method of claim 6, further comprising:
establishing the time duration from the start of the initiating transfer of the content.

8. The method of claim 1, further comprising:
translating a term from the first license to the second license.

9. The method of claim 1, further comprising:
implementing a particular right from the first license into the second license whereby the particular right is not directly supported in a DRM associated with the second license.

10. The method of claim 9, wherein the particular right includes expiration of playback ability after a period of time.

11. An apparatus for presenting content in a receiving device, the apparatus comprising:
a processor;
a computer-readable storage device including one or more instructions executable by the processor for:
initiating transfer of the content from a sending device to the receiving device, wherein the content is associated with a first license, wherein the first license includes at least one digital rights management term;
in response to the initiating transfer, communicating with a license provider;
challenging the receiving device to identify at least a portion of the content;
receiving a second license in association with the content, wherein the second license includes at least one license right that differs from the at least one digital rights management terms; and
presenting the content in accordance with at least one term in the second license.

12. A computer-readable storage device including instructions executable by a processor for presenting content in a receiving device, the computer-readable storage device comprising one or more instructions for:
initiating transfer of the content from a sending device to the receiving device, wherein the content is associated with a first license, wherein the first license includes at least one digital rights management term;
in response to the initiating transfer, communicating with a license provider;
challenging the receiving device to identify at least a portion of the content;
receiving a second license in association with the content, wherein the second license includes at least one license right that differs from the at least one digital rights management terms; and
presenting the content in accordance with at least one term in the second license.
